(19) United States
(12) Patent Application Publication
(10) Pub. No.: US 2011/0310503 A1
(43) Pub. Date: Dec. 22, 2011

(54) MIRROR ASSEMBLY FOR VEHICLES AND VEHICLE HAVING SAID MIRROR ASSEMBLY

(76) Inventor: Heinrich Lang, Ergersheim (DE)

(21) Appl. No.: 13/148,926

(22) PCT Filed: Feb. 17, 2010
(86) PCT No.: PCT/EP2010/051978

§ 371 Date: Aug. 10, 2011

(30) Foreign Application Priority Data
Feb. 18, 2009 (DE) 10 2009 009 379.6

(51) Int. Cl. G02B 5/10; G02B 5/09

(52) U.S. Cl. 359/864; 359/850

(57) ABSTRACT

The invention relates to a mirror assembly for vehicles comprising a plurality of glass units (24, 32, 12, 14, 20, 22), spatially separated from one another, wherein one glass unit (24, 32) comprises mirror glass (30, 34) and a frame (28, 36) surrounding said mirror glass (30, 34) and one of the glass units (24, 32) has a permanent visual marking (38, 40).

The present invention relates to a mirror assembly for vehicles in accordance with the preamble of claim 1 and a vehicle according to claim 11 having said mirror assembly.

In recent years, utility vehicles are being equipped with a steadily increasing number of rear-view mirrors allowing the driver to view areas located behind him as well as dead-angle areas. Particularly in the case of utility vehicles with a trailer and when approaching ramps or backing up, for example, it is necessary for the driver to obtain a view as comprehensive as possible of the areas to the left and right of the vehicle. While maneuvering in narrow spaces, the driver's viewing direction keeps changing back and forth, i.e., the driver checks the vehicle by alternatingly looking at left and right external mirrors. Here the eye always requires a certain time span for “locating” a particular mirror from among a plurality of mirrors that are arranged, e.g., adjacent to each other or on different sides of the vehicle. Such locating of the momentarily needed mirror may moreover be rendered difficult if the areas that are open to view through the individual mirrors present different degrees of brightness. Depending on personal habit, this will result in the driver preferably looking into the brighter, darker, upper, lower, more convexly curved or less convexly curved mirror. In a situation where the individual mirrors image similar objects or identical objects from slightly different perspectives, e.g., when starting from one of several identical ramps, the driver may moreover easily let himself be guided by a “wrong mirror” (or mirror image). Presumably the most critical situation does, however, come about in a driving situation in which the glance will shift rather less frequently between several mirrors, so that the “training effect of capturing” the correct mirror as well as accommodation to the area shown therein will come about less rapidly than would be the case during “normal” running such as, e.g., on a highway. For example, there exists a risk of the eye—which usually only observes the left external mirror during forward running—will take too long for singling out the correct one from among several right-hand external mirrors in order to complete a passing maneuver.

From EP 1 253 573 A2 a warning apparatus in automotive vehicles is known whereby upon occurrence of a danger situation the driver's glance is directed to the appropriate mirror as that the mirror is associated to a sensor of the vehicle which detects, e.g., a rearward distance of the automotive vehicle from an obstacle, and the mirror is marked, for example by driving a lighting means (e.g., an LED) affixed to it or integrated into it, as soon as this distance becomes smaller than a predetermined distance.

It is a drawback in the warning apparatus proposed in EP 1 253 573 A2 that its effect, which consists in directing the driver's glance to the appropriate mirror, will manifest upon occurrence of a danger situation only and exclusively, for instance when a distance becomes smaller than a minimum distance (while being cancelled again after the danger situation has been resolved), i.e., depending on the situation but not as a general rule.

Further mirror assemblies that are particularly suited for the use of the present invention are known from DE 102007013028 A1, DE 10036875 A1, DE 7702748 U1, DE 7815094 U1, and DE 19627 417 01.

Starting out from EP 1 253 573 A2 it is therefore the object of the present invention to specify a mirror assembly which enhances the running and traffic safety permanently and independently of a situation. Moreover it is an object of the present invention to specify a vehicle having said mirror assembly.

This object is achieved through the features of claims 1 and 11, respectively.

Due to the permanent visual marking of one of a plurality of glass units in a mirror assembly, the driver's attention is directed to this marked mirror. This results in a shortened perceptional time span. What is being referred to as a perceptional time span in this context is the time interval from the decision to monitor the traffic space with the aid of the mirror assembly up to the recognition of the relevant dangers in the one respective mirror most appropriate for that situation. Enhanced safety is thus achieved in a simple manner and without any additional sensors and electronics. Humans very quickly learn to subconsciously establish contexts from visual impressions. As a result, even after a few glances into the mirrors, the allocation of a viewing direction to a mirror presenting the associated viewing area is stored automatically, together with the visual impression of the mirror itself As soon as the driver subconsciously recalls an advantageous field of view based on the given running situation, he will immediately look into the correct mirror. The swiftness required for selecting the mirror that is advantageous for the respective running situation is hereby increased. Advantageously, the mirror assembly of the invention presents visual discernibility between a main mirror and a wide-angle mirror, to thus enable faster focusing of the eye on the mirror that is desired in the respective situation.

Due to the advantageous aspect of the invention according to claim 2, the main mirror is provided with the permanent visual marking. As it will be mandatory in most cases to check the field of view of the main mirror when looking into the rear-view mirror of a vehicle (field of view according to Group H or III of Guideline 2003/97/EC of the European Parliament and the Council of Oct. 10, 2003), the perceptional time span is shortened in particular, for the attention is directed to the main mirror from the very beginning by the permanent visual marking.

According to an aspect according to claim 4, the permanent visual marking consists in the mirror glass of the main mirror having a color tone different from the mirror glass of the additional mirror(s). Due to this choice the viewed mirror images reproduce different color impressions, which results in facilitated association of a color impression to a field of view.

An advantageous choice for different color tones for the mirror consists in the combination of a mirror glass in a traditional realization, e.g. as a chrome-plated mirror, and the realization of the other mirror glass as a blue mirror, as is known, e.g., from DE 20 2006 015 876 A1 (Claim 5).

According to another advantageous realization of the invention according to claim 6, the permanent visual marking is realized through different degrees of reflectivity of the various glass units. In addition the different degree of brightness constitutes another advantage which is particularly important in the twilight hours and at night, when good view is especially important. Selecting a darker main mirror and a more highly reflective wide-angle mirror in this combination provides the following advantages: Vehicles approaching from afar which are therefore observed with the aid of the main mirror present less glare to the driver than in a normal case. The closer surroundings, on the other hand, may be observed at normal intensity, which is even accentuated more strongly by the difference from the main mirror. Due to the clearly more pronounced curvature of the wide-angle mirror, on the other hand, glare is at any rate clearly reduced in comparison with the main mirror.

The difference in the degree of reflectivity between main mirror and wide-angle mirror is preferably at least 10%—Claim 7.

The permanent visual marking may be realized in a particularly simple manner in the form of a color marking—Claim 8. In this case the individual mirrors themselves or the frame of the respective mirror may be provided with a permanent color marking. A color marking is easy to apply and may be designed in a visually conspicuous manner, resulting in a high attention value.

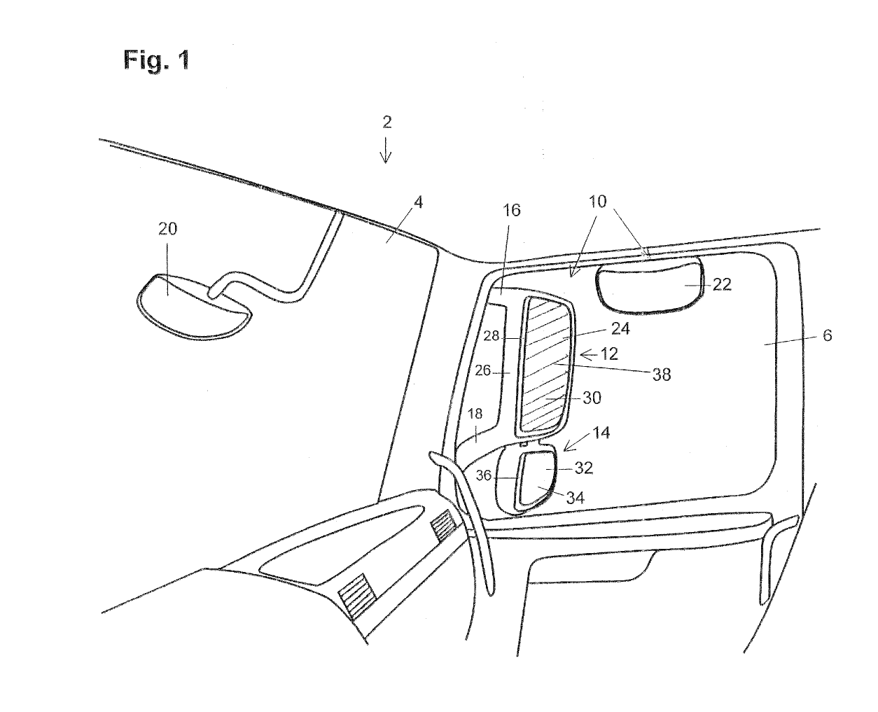

As may be seen from FIG. 1, it is advantageous particularly for mirrors arranged in close proximity of each other, for example a main mirror and another mirror, to provide a marking of only one glass unit. In the case of utility vehicles, the second mirror generally is the wide-angle mirror, as is represented in FIG. 1. Likewise, in the case of bus mirrors (not shown), for instance, combinations of the main mirror with a mirror for observing the boarding area are customary.

The remaining subclaims relate to further advantageous aspects of the invention. Additional details, features and advantages of the present invention become evident from the following description of preferred embodiments while making reference to the appended drawings, wherein:

FIG. 1 is a schematic representation of the view from the driver's cabin of a truck onto a mirror assembly in accordance with a first embodiment of the present invention;

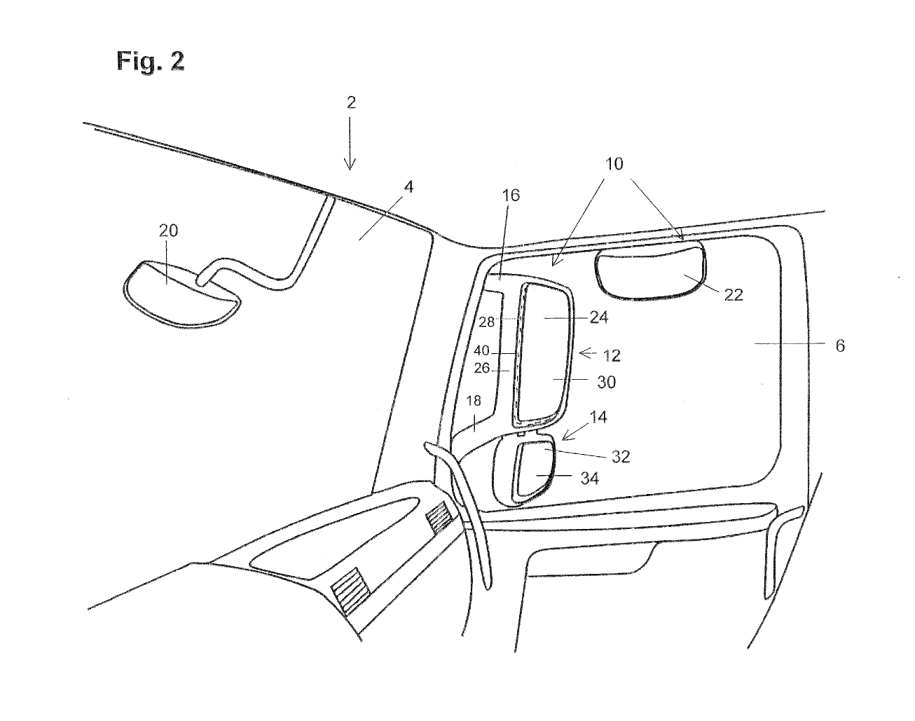

FIG. 2 is a representation in analogy with FIG. 1 of a second embodiment of the present invention; and

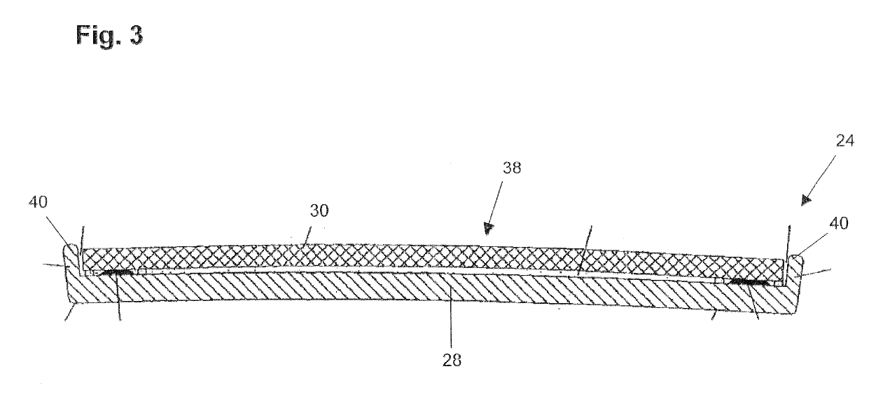

FIG. 3 is a sectional view of the glass unit of the main mirror.

FIG. 1 schematically shows the view from the driver's cabin of a truck 2, obliquely to the front right through a windshield 4 and a right side window 6, onto a mirror assembly 10 including a plurality of mirrors. The mirror assembly 10 comprises a main mirror 12 and a wide-angle mirror 14 disposed below the latter. The mirrors 12, 14 are fastened to a right side of the vehicle 2 through the intermediary of respective suitable mirror arms 16 and 18. A front mirror 20 protrudes from above into the driver's field of view. With the aid of the front mirror 20, the driver can observe the area immediately in front of the vehicle 2. On the right vehicle side a ramp mirror 22 projects from above and is visible to the driver through the right side window. With the aid of the ramp mirror 22 the driver can observe the area immediately to the right beside the vehicle 2.

In accordance with the representation in FIG. 1, the main mirror 12 comprises a glass unit 24 which is disposed inside a mirror housing 26. The glass unit 24 in turn comprises a frame 28 having a mirror glass 30 fixed therein. In the top view of the mirror glass 30, the frame 28 is visible on the edge of the mirror glass 30. The wide-angle mirror 14 equally comprises a glass unit 32 having a mirror glass 34 which is fixed in a frame 36 in an analogous manner.

In the embodiment according to FIG. 1, the mirror glass 30 of the main mirror 12 presents a blue tone whereby it is visually differentiated from the wide-angle mirror 14 and whereby the permanent visual marking is realized. In FIG. 1 this blue tone is represented by a cross-hatching 38 of the mirror glass 30. In contrast, the mirror glass 34 of the wide-angle mirror 14 is a chrome-plated mirror presenting a rather color-neutral impression. Likewise, the mirror glasses of front mirror 20 and ramp mirror 22 are realized in a color-neutral design. Due to this conspicuous difference between the main mirror 12 and the additional mirrors 14, 20, 22 of the mirror assembly 10, the driver's attention is first of all directed to the main mirror 12, i.e., to the mirror having the field of view that will be needed most often.

In addition, or alternatively, the permanent visual marking may also be realized by the degree of reflectivity of the mirror glass 30 of the main mirror 12 being lower than the degree of reflectivity of the mirror glass 34 of the wide-angle mirror 14—not represented. The different degree of brightness constitutes another advantage which is particularly important in the twilight hours and at night, when good view is especially important. Selecting a darker main mirror glass 30 and a more highly reflective wide-angle mirror glass 34 in this combination provides the following advantages: Vehicles approaching from afar which are therefore observed with the aid of the main mirror 12 present less glare to the driver than in a normal case. The closer surroundings, on the other hand, may be observed at normal intensity, which is even accentuated more strongly by the difference from the main mirror 12. Due to the clearly more pronounced curvature of the wide-angle mirror 14, on the other hand, glare is at any rate clearly reduced in comparison with the main mirror.

FIG. 2 schematically shows an alternative aspect of the invention which only differs from the embodiment of FIG. 1 in that the visually permanent marking is realized through the color of the frame 28 of the main mirror 12, which is differentiated from the color of the housing 26 having the customary black coloring and the frame 36 of the wide-angle mirror by a high color contrast. For example, the frame 28 may be colored in a bright red or orange color. This is represented by a hatching 40. The visually permanent different coloring 40 of the frame 28 of the main mirror 12 equally serves to direct the driver's attention first of all to the main mirror 12.

Alternatively, the visually permanent marking may also be realized through single color spots or illuminated fields (not represented).

Although the present invention has been disclosed with a view to the preferred embodiments so as to enable enhanced comprehension of the latter, it should be noted that the invention may be realized in different ways without departing from the scope of the invention. Accordingly, the invention should be understood to encompass any possible embodiments and aspects for the shown embodiments that may be realized, without departing from the scope of the invention as set forth in the appended claims.

### LIST OF REFERENCE NUMERALS

2 vehicle, truck
4 windshield
6 right side window
10 mirror assembly
12 main mirror
14 wide-angle mirror
16 upper retaining arm
18 lower retaining arm
20 front mirror
22 ramp mirror
24 glass unit of the main mirror
26 mirror housing of the main mirror
28 frame of the main mirror
30 mirror glass of the main mirror
32 glass unit of the wide-angle mirror
34 mirror glass of the wide-angle mirror
36 frame of the wide-angle mirror
38 visually permanent marking, blue tone, cross-hatching
40 visually permanent marking, frame color, hatching

1. A mirror assembly for vehicles comprising a plurality of spatially separate glass units, wherein:
the glass units each consist of a mirror glass and a frame surrounding said mirror glass,
at least one of said glass units is provided with a permanent visual marking, and
said permanent visual marking consists of color markings of the frame of the respective glass unit.

2. The mirror assembly according to claim 1, characterized in that one of said glass units comprises a mirror glass having a field of view of a main mirror according to Class II or III of Directive 2003/97/EC of the European Parliament and of the Council of Nov. 10, 2003, and in that this main mirror glass unit is provided with said permanent visual marking.

3. The mirror assembly according to claim 2, characterized in that another glass unit comprises a mirror glass having a field of view of a wide-angle mirror according to Class IV of Directive 2003/97/EC of the European Parliament and of the Council of Nov. 10, 2003.

4. The mirror assembly according to claim 1, characterized in that said permanent visual marking is the color tone of the respective mirror glass.

5. The mirror assembly according to claim 4, characterized in that said color tone is a blue tone.

6. The mirror assembly according to claim 1, characterized in that said permanent visual marking consists in the degree of reflectivity of the respective mirror glass.

7. The mirror assembly according to claim 6, characterized in that the degree of reflectivity of the mirror glass of a main mirror according to Class II or III at nocturnal lighting is at least 10% less than the degree of reflectivity of the other mirror glasses.

8. The mirror assembly according to claim 1, characterized in that the mirror assembly comprises a housing having the glass units disposed therein, and in that the permanent visual marking is realized by the frame of one glass unit having a different color than the housing of the mirror assembly.

9. The mirror assembly according to claim 1, characterized in that at least one glass unit having a visual marking together with at least one further glass unit not having a visual marking form a common part of a mirror system which is provided with a common mount for fastening to the vehicle.

10. The mirror assembly according to claim 1, further comprising said vehicle.

11. The mirror assembly according to claim 2, further comprising said vehicle.

12. The mirror assembly according to claim 3, further comprising said vehicle.
